(19) United States
(12) Patent Application Publication
(10) Pub. No.: US 2004/0263980 A1
(43) Pub. Date: Dec. 30, 2004

(54) Method and apparatus for simultaneoulsy reading out squared components of a vector represented by a plurality of holographic gratings

(76) Inventor: Christopher John St Clair Webber, Worcs WR14 3PS (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/496,063

(22) PCT Filed: Nov. 13, 2002
(86) PCT No.: PCT/GB02/05132

(30) Foreign Application Priority Data
Nov. 23, 2001 (GB) 0128078.3

(51) Int. Cl. G02B 5/18

(52) U.S. Cl. 359/569

(57) ABSTRACT

A method of simultaneously reading out squared components of a vector represented by a plurality of holographic gratings comprising the steps of generating a reference wave of known amplitude and diffracting the reference wave from each holographic grating to produce a plurality of diffracted waves each of which has an intensity proportional to the square of a component of the vector. The method allows squared components of the vector to be read out in parallel increasing the speed at which they may be processed compared to standard electronic techniques.

The invention relates to a method and apparatus for simultaneously reading out the squared components of a vector represented by a plurality of holographic gratings.

Optical computing techniques offer improvements in processing speed, parallelism and data storage density over conventional electronic computing techniques. Optical processing methods and apparatus are especially suited to tasks which are computationally intensive and intrinsically parallelisable, for example matrix multiplication in signal processing problems and execution of neural network and template matching algorithms. In the case of neural network algorithms, conventional electronic computing techniques are relatively inefficient in carrying out low-level, massively interconnect-intensive computations involved in such algorithms. To carry out some of these computations electronically currently requires weeks of workstation time.

In algorithms such as those used to implement template matching and neural networks, it is frequently necessary to read out squared components wⱼᵢ² of a stored vector wⱼ. For example in the case of neural networks, calculation of the squared modulus of a neuron's synaptic weight vector is required to evaluate the direction cosine between a weight vector and a pattern vector, and is also required in neural network training. This calculation requires the squared components of the synaptic weight vector to be read out from a memory and then summed. Presently such reading out is carried out serially, which is inefficient if the synaptic weight vector has a large number of components.

It is an object of the invention to provide an alternative method of reading out squared components of a vector represented by a plurality of holographic gratings.

According to a first aspect of the present invention, there is provided a method of simultaneously reading out squared components of a vector represented by a plurality of holographic gratings, characterised in that the method comprises the steps of:

(i) generating a reference wave of known amplitude; and

(ii) diffracting the reference wave from each holographic grating to produce a plurality of diffracted waves each of which has an intensity proportional to the square of a component of the vector.

A method of the invention provides the advantage that the squared components of a stored vector are read out in parallel (i.e. simultaneously) thus providing for faster read out and processing of the squared components than is achievable by electronic means. The method is particularly advantageous when the stored vector has a very large number of components, as is the case, for example, in neural network applications.

A method according to the invention may further comprise the step of summing the intensities of the diffracted waves to generate a signal corresponding to the squared modulus of the vector.

According to a second aspect of the invention, there is provided an apparatus for simultaneously reading out squared components of a vector represented as a plurality of holographic gratings, the apparatus comprising a medium storing the holographic gratings, characterised in that the apparatus further comprises generating means for generating a reference wave of known amplitude and means for diffracting the reference wave from each holographic grating to produce a plurality of diffracted waves each of which has an intensity proportional to the square of a component of the vector.

Preferably, the generating means comprises a spatial light modulator for generating the reference wave, the spatial light modulator being arranged such that the reference wave is diffracted by each holographic grating to produce a plurality of diffracted waves each of which has an amplitude proportional to the square of a component of the vector. This allows the direction of the reference wave to be easily varied, providing for read-out of squared components of a series of vectors each of which is represented as a plurality of holographic gratings stored in the holographic medium.

Preferably the apparatus includes summing means for summing the diffracted waves to generate a signal corresponding to the squared modulus of the vector. This allows optical processing in which the vector's squared modulus is required.

Conveniently, the summing means is a photodiode. The medium may be a photorefractive medium; such media allow modification and erasure of holographic gratings stored therein. Alternatively, the medium may be a photochemical polymer. Photochemical polymers have the advantage that gratings formed within them persist indefinitely.

Embodiments of the invention will now be described, by way of example only, with reference to the accompanying drawings in which:

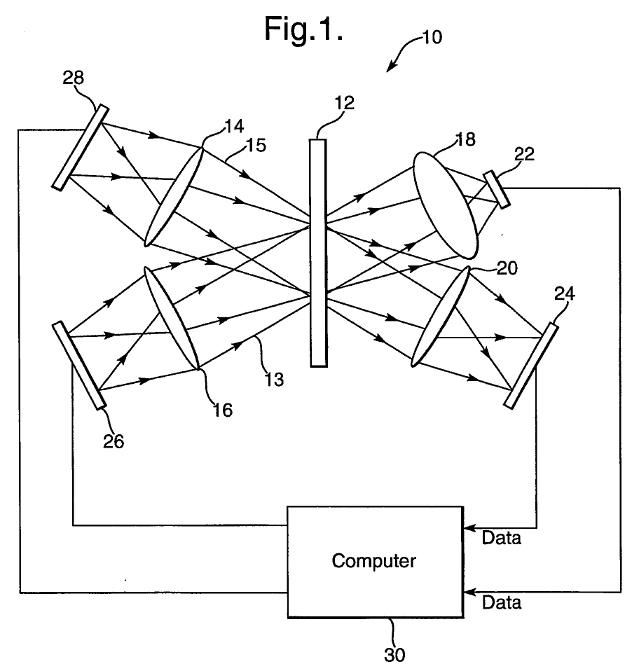

FIG. 1 shows an apparatus of the invention for implementing template matching (including computation of scalar products in neural network algorithms);

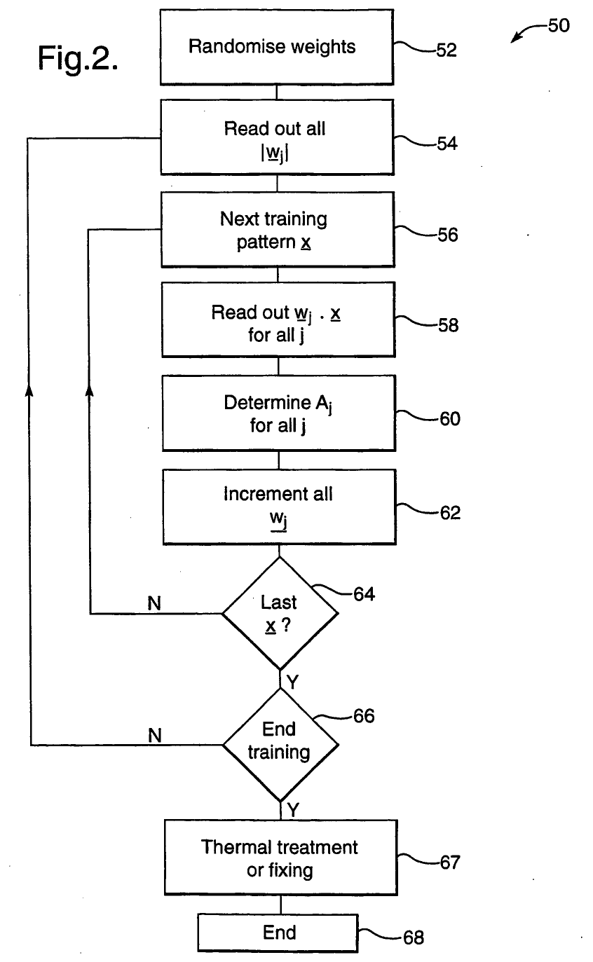

FIG. 2 illustrates a neural learning algorithm for training the FIG. 1 apparatus;

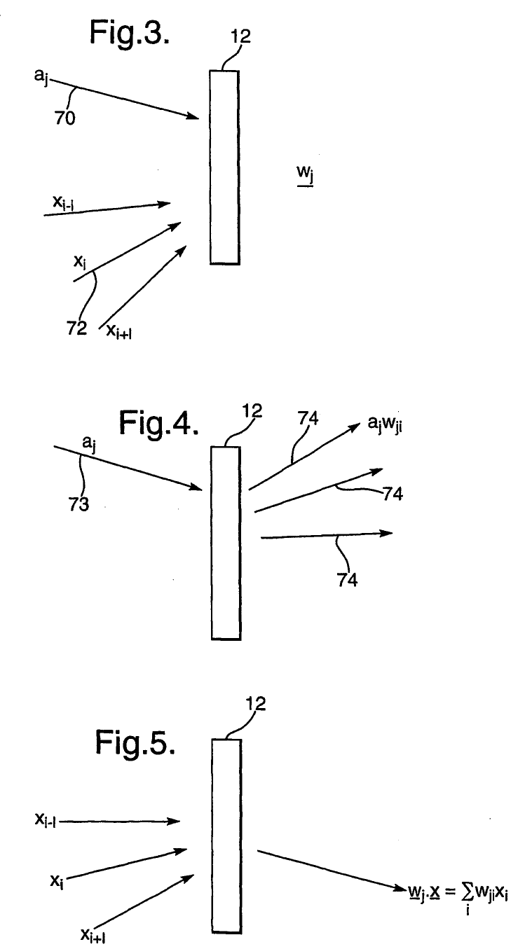

FIG. 3 illustrates modification of a plurality of holographic gratings representing a weight vector wⱼ by interference of a reference beam of amplitude aⱼ with a plurality of image beams representing an image vector x which has a general component xᵢ;

FIG. 4 illustrates optical read-out of the squared components of a weight vector stored in the FIG. 1 apparatus; and

FIG. 5 illustrates optical computation of the inner product of a stored weight vector wⱼ and an image vector x.

Referring to FIG. 1 there is shown an apparatus of the invention, indicated generally by 10, for carrying out template matching. In template matching using the apparatus 10, input image data is supplied to the apparatus 10 and compared to image data which is stored in the apparatus 10 to produce a quantitative measure of the degree of correlation between the input image data and the stored image data.

The apparatus 10 comprises a writable holographic recording medium 12 of phenathrenequinone-doped polymethyl methacrylate (PQ/PMMA), converging lenses 14, 16, 18, 20, amplitude spatial light modulators (SLMs) 26, 28 fitted with microlens arrays (not shown), a single optical detector 22 (for example a photodiode), a detector array 24 and a computer 30. The SLMs 26, 28 are each illuminated by a coherent light source (not shown). Data from the single detector 22 and the detector array 24 is passed to the computer 30 which applies control signals to operate the SLMs 26, 28. Image waves 13 from the SLM 26 may be interfered with reference waves 15 from the SLM 28 to record holographic gratings in the element 12. By interfering image waves with a series of reference waves each of which has a different wave-normal direction, pluralities of holographic gratings may be recorded in the element 12. Each plurality of gratings corresponds to a neuron in a neural network implemented by the apparatus 10.

The lenses 16, 18 form a telescope which brings an image of the SLM 26 into focus at the single detector 22. Similarly, the lenses 14, 20 form a telescope which brings an image of the SLM 28 into focus at the detector array 24.

In order for the apparatus 10 to perform template matching, it must first be trained using training data in the form of sets of image data. FIG. 2 shows a neural learning algorithm 50 for training the apparatus 10 to carry out template-matching. The algorithm 50 is executed as follows.

Initially, the holographic element 12 is randomised (52) by interfering random image waves generated by random image data supplied to the SLM 26 with a series of reference waves having different wave-normal directions but a fixed amplitude aⱼ. Different wave-normal directions are achieved by activating different regions of the SLM 28. Random image data is supplied electronically to the SLM 26 by the computer 30 to generate the random image waves, which may be collectively represented by an image vector x. Pluralities of holographic gratings are thus produced, each of which corresponds to a particular wave-normal direction of a reference wave. Elements xᵢ of the random image vector x represent amplitudes of individual pixels of the SLM 26. Referring to FIG. 3, interference of a reference wave 70 of amplitude aⱼ with an image vector x (having elements xᵢ 72) records a plurality of holographic gratings in the element 12 which represent a weight-vector wⱼ. Elements wⱼᵢ=aⱼxᵢ of the weight vector wⱼ thus generated have random values.

The modulus |wⱼ| of the weight vector associated with each wave-normal direction is then determined (step 54 in FIG. 2) by illuminating the element 12 with a series of reference waves, such as 73, from the SLM 28 as shown in FIG. 4. Each reference wave in the series has a different direction and is diffracted by a particular plurality of gratings, as shown in FIG. 4. When a particular reference wave having a particular direction addresses a plurality of gratings corresponding to that direction, a series of diffracted waves 74 is produced each of which has an amplitude proportional to aⱼwⱼᵢ and hence an intensity proportional to aⱼ²wⱼᵢ². Each of the diffracted waves 74 is focused by the converging lens 18 at the detector 22, which produces a signal proportional to

$${a}_{j}^{2} {\sum }_{i}^{} {w}_{ji}^{2} = {a}_{j}^{2} {\vert {w}_{j} \vert}^{2}$$

(i.e. the total intensity of the diffracted waves focused at the detector 22), from which the modulus |wⱼ| of the weight vector is deduced by the computer 30.

After the modulus |wⱼ| of each weight-vector wⱼ has been read out by addressing each plurality of gratings with a reference wave of a corresponding direction, a first training pattern, represented by an image vector x, is generated at the SLM 26 under control of the computer 30 (step 56 in FIG. 2). As illustrated in FIG. 5, image waves represented by an image vector x having individual elements xᵢ, from the SLM 26 is diffracted by the j^{th} plurality of gratings in the element 12 to produce a diffracted wave having an amplitude proportional to

$${\sum }_{i}^{} {w}_{ji} {x}_{i} = {w}_{j} \cdot x .$$

Light corresponding to the image vector x is diffracted from each plurality of gratings wⱼ stored in the element 12 to produce a beam having an amplitude proportional to wⱼ·x. Each such beam has a unique direction and is focused to a pixel of the detector array 24 by the converging lens 20. Corresponding signals are passed to the computer 30 which stores the values wⱼ·x for each j. wⱼ·x is a measure of the overlap between the weight vector wⱼ and the training vector x. wⱼ·x is simultaneously evaluated for all neurons j (i.e. for all pluralities of gratings stored in the element 12) in parallel by illuminating the element 12 with the training pattern represented by x and the plurality of reference waves of amplitude aⱼ. For each neuron j an update magnitude Aⱼ is then calculated (step 60 in FIG. 2) by the computer 30 as follows (for example):

Aⱼ=wⱼ·x−|wⱼ|θⱼif wⱼ·x<|wⱼ|θⱼ ;Aⱼ=0 otherwise,

where θⱼ is the j^{th} neuron's threshold parameter.

Referring again to FIG. 3, all weight vectors wⱼ are then simultaneously updated (step 62 in FIG. 2) to produce updated weight-vectors w′ⱼ where

w′ⱼ=wⱼ+Aⱼx

by interfering the image vector x with all reference waves in parallel, the reference waves each having an amplitude of the form aⱼ=Aⱼ.

Modification of the updated weight vectors wⱼ′ is carried out optically. All the weight vectors are simultaneously updated as follows. Data corresponding to the image vector x is passed to the SLM 26 and a plurality of image waves thus generated is interfered with a plurality of reference waves, each having a direction corresponding to a particular plurality of recorded gratings, and each having an amplitude of the form Aⱼ.

Updating of weight vectors is then repeated using remaining image vectors x in the training data (64). After all training vectors x have been used to increment the weight vectors wⱼ, the modulus |wⱼ| of each weight vector is read out as previously described (66). New values for |wⱼ| thus obtained are then used in further training using the set of training vectors x.

Following training, the element 12 is heat treated (67) to render the gratings stored therein suitable for read-out, and the neural learning algorithm 50 is then terminated (68). The apparatus 10 may then be used for template matching in a manner familiar to those skilled in the art.

PQ/PMMA is an example of a photochemical polymer. These polymers have the advantage that gratings stored within them persist indefinitely.

Alternatively, the holographic recording medium 12 may be a photorefractive medium, for example iron-doped lithium niobate. A photorefractive medium has the advantage that gratings stored within it may be erased. However, when reading out squared components of a vector stored as a plurality of gratings within a photorefractive medium, the gratings may become wholly or partially erased. This problem may be overcome by so-called “two-colour recording” in which gratings are formed by interference of two beams of a first wavelength, but information stored therein is read out using light of a second wavelength which does not give rise to a photorefractive effect in the medium. Two-colour recording is described, for example, by Gunther et al, Applied Optics, volume 37, pp 7611-7623 (1998). Reduced stoichiometric lithium niobate is a suitable material for two-colour recording.

Production of holographic gratings representing vectors is well-known and is reviewed, for example, by Ashley et al in the paper “Holographic data storage”, IBM Journal of Research & Development, volume 44, No 3 (May 2000). Use of photorefractive media to store holographic gratings is described, for example, by Hesselink et al in the paper “Optical Memories Implemented with Photorefractive Media”, Optical & Quantum Electronics, volume 25, pp 611-651 (1993). Use of PQ/PMMA as a medium for storage of holographic gratings is described, for example, by Stechman et al in the paper “Characterisation of Phenanthrenequinone-doped Poly(methylmethacrylate) for Holographic Memory”. Optics Letters, volume 23, pp 1310-1312 (1998).

1. A method of simultaneously reading out squared components of a vector represented by a plurality of holographic gratings, characterised in that the method comprises the steps of:
i) generating a reference wave of known amplitude; and
ii) diffracting the reference wave from each holographic grating to produce a plurality of diffracted waves each of which has an intensity proportional to the square of a component of the vector.

2. A method according to claim 1 further comprising the step of summing the intensities of the diffracted waves to generate a signal corresponding to the squared modulus of the vector.

3. An apparatus for simultaneously reading out squared components of a vector represented as a plurality of holographic gratings, the apparatus comprising a medium storing the holographic grating, characterised in that the apparatus further comprises generating means for generating a reference wave of known amplitude and means for diffracting the reference wave from each holographic grating to produce a plurality of diffracted waves each of which has an intensity proportional to the square of a component of the vector.

4. An apparatus according to claim 3 wherein the generating means comprises a spatial light modulator for generating the reference wave, the spatial light modulator being arranged such that the reference wave is diffracted by each holographic grating to produce a plurality of diffracted waves each of which has an amplitude proportional to the square of a component of the vector.

5. An apparatus according to claim 3 wherein the apparatus further comprises summing means for summing the diffracted waves to generate a signal corresponding to the squared modulus of the vector.

6. An apparatus according to claim 5 wherein the summing means is a photodiode.

7. An apparatus according to claim 3 wherein the medium is a photorefractive medium.

8. An apparatus according to claim 3 wherein the medium is a photochemical polymer.

9. An apparatus according to claim 4 wherein the apparatus further comprises summing means for summing the diffracted waves to generate a signal corresponding to the squared modulus of the vector.

10. An apparatus according to claim 4 wherein the medium is a photorefractive medium.

11. An apparatus according to claim 4 wherein the medium is a photochemical polymer.
